(19) United States
(12) Patent Application Publication
(10) Pub. No.: US 2023/0384735 A1
(43) Pub. Date: Nov. 30, 2023

(54) APPARATUS AND METHOD FOR GENERATING HOLOGRAM

(71) Applicant: Electronics and Telecommunications Research Institute, Daejeon (KR)

(72) Inventor: Jeho NAM, Daejeon (KR)

(73) Assignee: Electronics and Telecommunications Research Institute, Daejeon (KR)

(21) Appl. No.: 18/325,706

(22) Filed: May 30, 2023

(30) Foreign Application Priority Data
May 31, 2022 (KR) 10-2022-0067056

(51) Int. Cl. G03H 1/04

(52) U.S. Cl. CPC G03H 1/0486; G03H 2225/34; G03H 2225/60; G03H 2001/0491

(57) ABSTRACT

There is provided an apparatus and method for generating a hologram through measuring intensity and a phase of a complex light wavefront that is output from a complex modulation spatial light modulator (SLM); determining characteristic information of the complex light wavefront by analyzing the measured intensity and phase of the complex light wavefront; creating distortion correction information for correcting distortion of the complex light wavefront from an artificial neural network by inputting the characteristic information to the artificial neural network; and feeding back the distortion correction information to the complex modulation SLM.

### CROSS REFERENCE TO RELATED APPLICATIONS

The present application is based on and claims the benefit of priority to Korean Patent Application Number 10-2022-0067056, filed on May 31, 2022 in the Korean Intellectual Property Office, the entire disclosure of which is incorporated herein by reference.

### TECHNICAL FIELD

The present disclosure relates to an apparatus and a method for generating a hologram.

### BACKGROUND

A spatial light modulator (SLM) is a microdisplay having a pixelated structure. Liquid Crystal on Silicon (LCoS) that uses liquid crystal (LC) and a digital micro-mirror display (DMD) that uses mechanical operations are representative SLMs. An SLM is a core device of various immersive display devices such as monitors, beam projectors, AR⋅VR devices, 3 D holography, etc.

A liquid crystal panel is a transmissive SLM and is generally used as a large-area display such as a digital TV, a PC monitor, etc., but it is difficult to develop into high resolution because it is difficult to manufacture a driving layer of a thin film transistor (TFT). However, a reflective SLM is relatively easily manufactured to have high resolution and can implement high-efficiency light modulation. As reflective SLMs, LCoS can typically be operated in a phase modulation scheme and a DMD can be operated in an amplitude modulation scheme.

However, according to SLMs that can perform only amplitude or phase modulation, various optical aberrations such as diffraction noise (DC, high-order term, conjugate image), speckle noise generated by wave optic characteristics, color aberration, and the like are generated in holographic displays due to limited modulation performance, and thus the image quality is significantly deteriorated.

### SUMMARY

An embodiment of the present disclosure provides a device for generating a hologram.

Another embodiment of the present disclosure provides a method of generating a hologram.

Yet another embodiment of the present disclosure provides a device for correcting a hologram.

According to an embodiment, an apparatus for generating a hologram is provided. The apparatus includes a complex wavefront measuring unit configured to measure an intensity and a phase of a complex light wavefront that is output from a complex modulation spatial light modulator (SLM), analyze the intensity and the phase of the complex light wavefront, and accordingly, determine characteristic information of the complex light wavefront; and a complex wavefront correction unit configured to create distortion correction information for correcting distortion of the complex light wavefront from an artificial neural network by inputting the characteristic information to the artificial neural network and feeding back the distortion correction information to the complex modulation SLM.

In the above embodiment, the complex modulation SLM is configured to update the complex light wavefront using the distortion correction information.

In the above embodiment, the complex wavefront measuring unit includes: a phase measuring unit configured to measure a phase of the complex light wavefront; an intensity measuring unit configured to measure the intensity of the complex light wavefront; and a distortion analyzing unit configured to determine characteristic information of the complex light wavefront by analyzing the measured phase and intensity of the complex light wavefront.

In the above embodiment, the phase characteristic information derived from the measured phase of the complex light wavefront includes a Zernike-based phase map.

In the above embodiment, intensity information derived from the measured intensity of the complex light wavefront includes at least one of a point spread function, a contrast ratio, a modulation transfer function, or a combination thereof.

In the above embodiment, the complex wavefront correction unit determines distortion correction information that can minimize distortion in a loss function showing the distortion in the characteristic information using the artificial neural network.

In the above embodiment, the complex modulation SLM includes a first SLM configured to modulate a phase, a second SLM configured to modulate an amplitude, and an optical device configured to combine beams of light modulated by the first SLM and the second SLM.

In the above embodiment, the first SLM, the second SLM, and the optical device are disposed to couple beams of light modulated by the first SLM and the second SLM in a complex multiplication method or a complex addition method.

According to another embodiment, a method of generating a hologram is provided. The method comprises measuring an intensity and a phase of a complex light wavefront that is output from a complex modulation spatial light modulator (SLM); determining characteristic information of the complex light wavefront by analyzing the measured intensity and phase of the complex light wavefront; creating distortion correction information for correcting distortion of the complex light wavefront from an artificial neural network by inputting the characteristic information to the artificial neural network; and feeding back the distortion correction information to the complex modulation SLM.

In the above embodiment, the method further comprises updating the complex light wavefront using the distortion correction information.

In the above embodiment, the measuring of an intensity and a phase of a complex light wavefront that is output from a complex modulation SLM includes: measuring a phase of the complex light wavefront; measuring the intensity of the complex light wavefront; and determining characteristic information of the complex light wavefront by analyzing the measured phase and intensity of the complex light wavefront.

In the above embodiment, phase characteristic information derived from the measured phase of the complex light wavefront includes a Zernike-based phase map.

In the above embodiment, intensity information derived from the measured intensity of the complex light wavefront includes at least one of a point spread function, a contrast ratio, a modulation transfer function, or a combination thereof.

In the above embodiment, the creating of distortion correction information for correcting distortion of the complex light wavefront from an artificial neural network by inputting the characteristic information to the artificial neural network includes determining distortion correction information that can minimize distortion in a loss function showing the distortion in the characteristic information using the artificial neural network.

In the above embodiment, before measuring an intensity and a phase of a complex light wavefront that is output from a complex modulation SLM, the method further comprises: modulating a phase of light using a first SLM; modulating an amplitude of the light using a second SLM; and outputting the complex light wavefront by coupling beams of light modulated by the first SLM and the second SLM.

In the above embodiment, the coupling of beams of light modulated by the first SLM and the second SLM includes coupling beams of light modulated by the first SLM and the second SLM in a complex multiplication method or a complex addition method.

According to another embodiment of the present disclosure, an apparatus for correcting a hologram is provided. The apparatus includes a processor, a memory; and a communication interface, wherein the processor is configured to execute programs stored in the memory, thereby performing: receiving characteristic information of a complex light wavefront, which is determined from a result of measuring an intensity and a phase of the complex light wavefront that is output from a complex modulation spatial light modulator (SLM), from the communication interface; creating distortion correction information for correcting distortion of the complex light wavefront from an artificial neural network by inputting the characteristic information of the complex light wavefront to the artificial neural network; and feeding back the distortion correction information to the complex modulation SLM through the communication interface.

It is possible to optimize transform of a complex hologram and maximize performance of a complex modulation SLM by inputting a measurement result of a complex wave-field output from the complex modulation SLM into a pre-trained artificial neural network to create distortion correction information and then feeding back the created distortion correction information to the complex modulation SLM.

### BRIEF DESCRIPTION OF THE DRAWINGS

FIG. 1 is a block diagram showing an apparatus for generating a hologram according to an embodiment.

FIG. 2 is a flowchart showing a method of generating a hologram according to an embodiment.

FIG. 3 is a block diagram showing a complex modulation SLM according to an embodiment.

FIG. 4A and FIG. 4B are diagrams showing an optical coupling method of a transmissive SLM according to an embodiment.

FIG. 5A and FIG. 5B are diagrams showing an optical coupling method of a reflective SLM according to an embodiment.

FIG. 6 is a block diagram showing a complex wavefront measuring unit according to an embodiment.

FIG. 7A to FIG. 7C are diagrams showing characteristic information that can be derived from the intensity of light according to an embodiment.

FIG. 8A and FIG. 8B are diagrams showing characteristic information that can be derived from the phase of light according to an embodiment.

FIG. 9 is a block diagram showing a complex wavefront correction unit according to an embodiment.

FIG. 10 is a block diagram showing an apparatus for correcting a complex hologram according to an embodiment.

### DETAILED DESCRIPTION

Hereinafter, the embodiments of the present disclosure are described in detail for those having ordinary skill in the art to easily practice, with reference to the accompanying drawings. The present disclosure, however, may be embodied in various forms, and should not be construed as being limited only to the illustrated embodiments. In the drawings, elements irrelevant to the present disclosure are omitted for the simplicity of explanation, and like reference numerals denote like elements throughout the entire specification.

Throughout this specification, when a part ‘includes’ or ‘comprises’ a component, the part is meant to further include other components, rather than to exclude other components, unless specifically stated to the contrary.

In the present specification, a singular expression may be interpreted as single or plural unless an explicit expression such as “one” or “single” is used.

As used herein, “and/or” indicates each of the stated components and all combinations of one or more of the stated components.

In the present disclosure, ordinal adjectives such as “first,” “second,” etc. may be used solely to differentiate one element from another but not to define the order or priority of elements. Accordingly, a first element so named in one embodiment may be renamed a second element in another embodiment without departing from the scope of the present disclosure. Likewise, a second element in one embodiment may be renamed a first element in another embodiment.

In the flowchart described with reference to the drawings in the present specification, the order of operations may be changed, several operations may be merged, a certain operation may be divided, and a specific operation may not be performed.

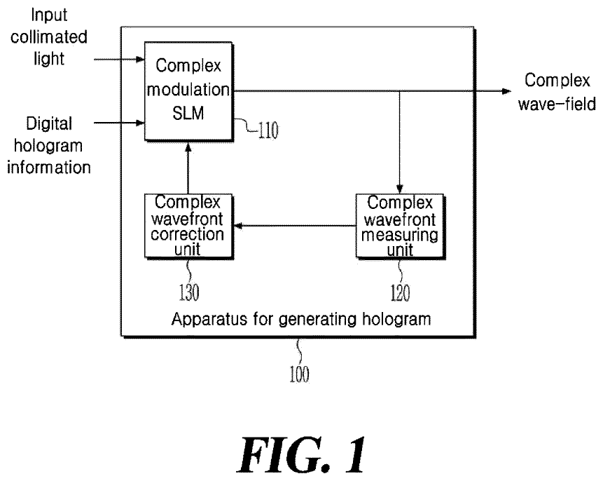

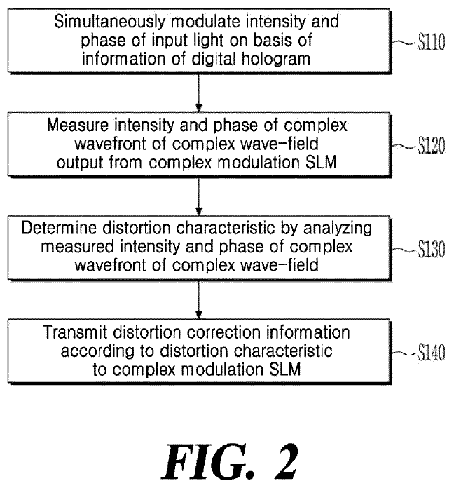

FIG. 1 is a block diagram showing an apparatus for generating a hologram according to an embodiment and FIG. 2 is a flowchart showing a method of generating a hologram according to an embodiment.

Referring to FIG. 1, an apparatus 100 for generating a hologram according to one embodiment may include a complex modulation spatial light modulator (SLM) 110, a complex wavefront measuring unit 120, and a complex wavefront correction unit 130.

Referring to FIG. 2, first, the complex modulation SLM 110 can simultaneously modulate the intensity (amplitude) and the phase of input collimated light (i.e., plane wave) based on the information of a digital hologram (S110). The complex modulation SLM 110 can output a complex wave-field having a certain light wavefront by adjusting (modulating) the intensity and the phase of input collimated light based on the information of a digital complex hologram.

Collimated light that is input into the complex modulation SLM 110 may be emitted from a coherence light source such as a laser or a partial coherence light source such as an LED. In one embodiment, a plane wave that is input into the complex modulation SLM 110 may be modulated into an output wave-field having a certain wavefront by the complex modulation SLM 110.

The complex wavefront measuring unit 120 and the complex wavefront correction unit 130 are components for accurately reproducing the intensity and the phase of a digital complex hologram. In one embodiment, the complex wavefront measuring unit 120 may measure the intensity and the phase of a complex wavefront of a complex wave-field that is output from the complex modulation SLM 110 (S120). The complex wavefront measuring unit 120 may determine characteristic information of a complex light wavefront by analyzing the measured intensity and phase of the complex wavefront (S130).

The complex wavefront correction unit 130 may receive the characteristic information about the intensity and the phase of the complex wavefront from the complex wavefront measuring unit 120, determine and transmit distortion correction information to the complex modulation SLM 110 based on the characteristic information (S140). Thereafter, the complex modulation SLM 110 can optimize complex modulation of input collimated light using the distortion correction information.

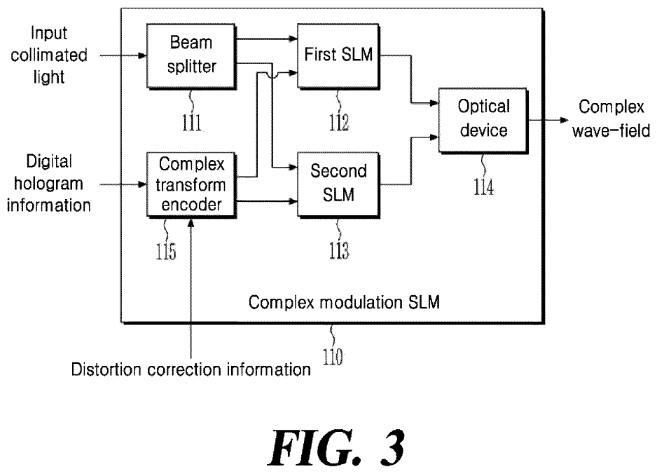

FIG. 3 is a block diagram showing a complex modulation SLM according to an embodiment.

An ideal SLM can implement complex modulation that simultaneously and independently controls the amplitude and the phase of light. The complex modulation SLM 110 is advantageous in that diffraction efficiency is excellent and a zeroth-order image (DC) or a conjugate image is not generated.

Referring to FIG. 2, the complex modulation SLM 110 according to an embodiment may include a beam splitter 111, a first SLM 112, a second SLM 113, an optical device 114, and a complex transform encoder 115.

Collimated light that is input into the complex modulation SLM 110 is split by the beam splitter 111, and each of the beams of light can be input into the first SLM 112 and the second SLM 113, respectively. The beams of light modulated by the first SLM 112 and the second SLM 113 are combined by the optical device 114 that is used for optical coupling, so that the beams of light can be output as a complex wave-field having a certain wavefront shape. In an embodiment, the amplitude |(U(x,y)| and the phase ϕ(x,y) of a complex wave-field that is output by the complex modulation SLM 110 are determined by the information of a digital complex hologram and may be expressed as Equation 1.

$$\begin{matrix}U ( x , y ) = \frac{1}{j λ z} {e}^{j \frac{k}{2 z} ( {x}^{2} + {y}^{2} )} \int \int \{ U ( ξ , η ) {e}^{j \frac{k}{2 z} ( {ξ}^{2} + {η}^{2} )} \} \\ {e}^{- j \frac{k}{2 z} ( x ξ + y η )} d ξ d η \\ = \vert U ( x , y ) \vert {e}^{j ϕ ( x , y )}\end{matrix} \qquad [ Equation 1 ]$$

In an embodiment, the first SLM 112 and the second SLM 113 may be a phase modulation SLM and an amplitude modulation SLM, respectively. An SLM may be a transmissive type or a reflective type. A liquid crystal (LC) display panel is representative of a transmissive SLM, and a liquid crystal on silicon (LCoS), a digital micromirror device (DMD), etc. are reflective SLMs.

Equation 2 shows a process in which beams of light that are output from each SLMs are coupled in a complex multiplication form.

|U(x,y)|e^{jϕ(x,y)}=|U(x,y)|×e^{jϕ(x,y)} [Equation 2]

Equation 3 shows a process in which beams of light that are output from each SLMs are coupled in a complex addition form.

|U(x,y)|e^{jϕ(x,y)}=Re[U(x,y)]+jlm[U(x,y)] [Equation 3]

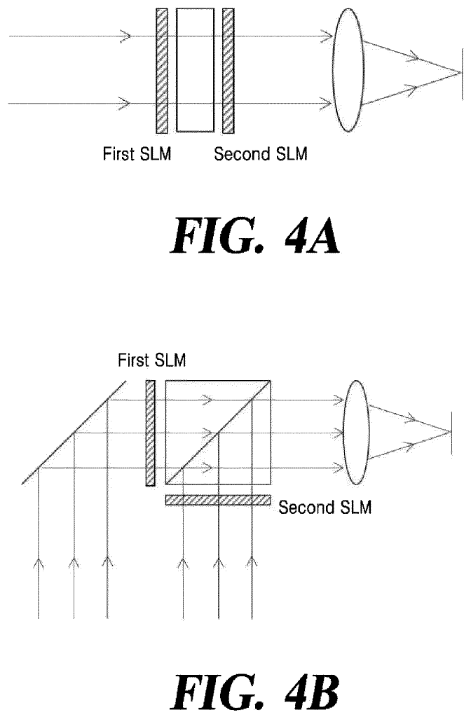

FIG. 4A and FIG. 4B are diagrams showing an optical coupling method of a transmissive SLM according to an embodiment.

In FIG. 4A, beams of light may be coupled in a multiplication method of amplitude and phase by sequentially passing through two transmissive SLMs (first SLM 112 and second SLM 113). In FIG. 4B, beams of light may be coupled in an addition method of the real part and the imaginary part of a complex number after being modulated in two transmissive SLMs.

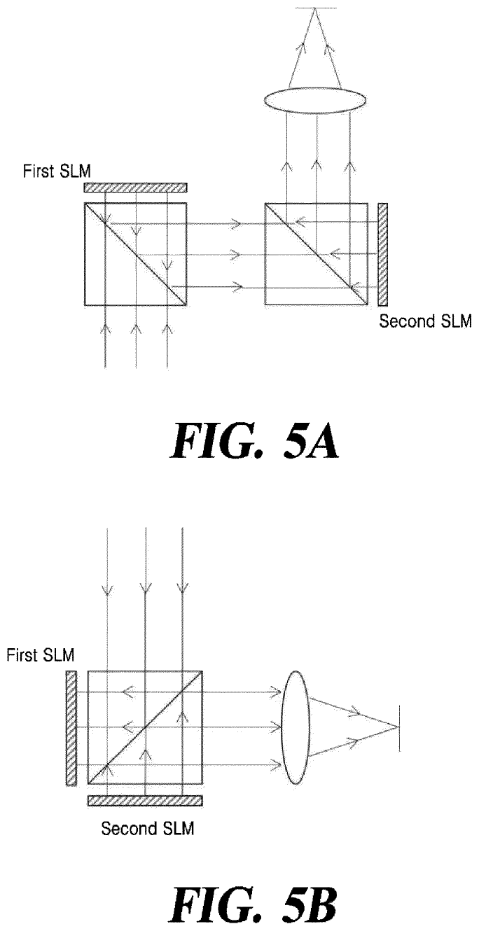

FIG. 5A and FIG. 5B are diagrams showing an optical coupling method of a reflective SLM according to an embodiment.

In FIG. 5A, beams of light may be coupled in a multiplication method of amplitude and phase by being sequentially reflected by two reflective SLMs (first SLM 112 and second SLM 113). In FIG. 5B, beams of light may be coupled in an addition method of the real part and the imaginary part of a complex number after being modulated in two reflective SLMs.

Referring to FIG. 2 again, the optical device 114 according to an embodiment can precisely couple beams of light modulated in two SLMs in the unit of pixel. In an embodiment, the optical device 114 for optical coupling can minimize cross-talk between adjacent pixels due to light diffusion by diffraction while maintaining coherence of light. For example, the optical device 114 may include a grating, a prism, a lens-array, etc.

When two transmissive SLM are combined to implement a complex modulation SLM and amplitude and phase are sequentially modulated, pixel unit arrangement at a very precise level may be required in the process of coupling beams of light between the two SLMs. When optical coupling between two SLMs is inaccurate, various noises such as cross-talk is induced, and the modulation performance may be deteriorated. Further, coupling of transmissive SLMs may have a defect of low luminance efficiency. In order to avoid the difficulty in the method of coupling two SLMs, a complex modulation function may be implemented as a macro-pixel comprising two or more pixels in one SLM. However, even in this case, the image quality is unavoidably decreased by reduction of effective resolution of the SLM according to a configuration of the macro-pixel.

In optical coupling of two SLMs for complex modulation, high precision is required to maintain coherence of modulated complex light waves. Precise optical coupling at the level of SLM pixel is difficult, but cross-talk noise due to a diffraction phenomenon of light that may be generated by a physical gap between two SLMs may also deteriorate modulation performance. Further, even in an amplitude modulation or phase modulation SLM, non-linearity distortion may be generated and there may non-uniform modulation in which all of the pixels in an SLM surface region cannot provide spatially uniform modulation performance.

In an optical coupling process between two SLMs, factors such as a matching error of pixel levels, cross-talk noise due to diffraction and interference of light, non-linearity modulation performance and spatial modulation non-uniformity of individual SLMs, etc. may act in combination, so there is limitation in a linear analysis and distortion correction method of the related art.

In an embodiment, the complex transform encoder 115 can optimize the modulation performance of the complex modulation SLM 110 by updating a complex hologram based on distortion correction information generated from a measurement result of a complex wave-field. The complex transform encoder 115 can use the distortion correction information as a complex transform filter for simultaneously updating the intensity and the phase of a complex hologram.

Equation 4 shows a method in which the complex transform encoder 115 updates a complex hologram.

U′(x,y)=ƒ(x,y)⊗U(x,y) [Equation 4]

In Equation 4, ƒ(x,y) may show distortion correction information. Distortion correction information for updating a complex hologram may be received from the complex wavefront correction unit 130. In an embodiment, the complex wavefront correction unit 130 can create distortion correction information by correcting the characteristics of a complex hologram that are measured based on an artificial neural network.

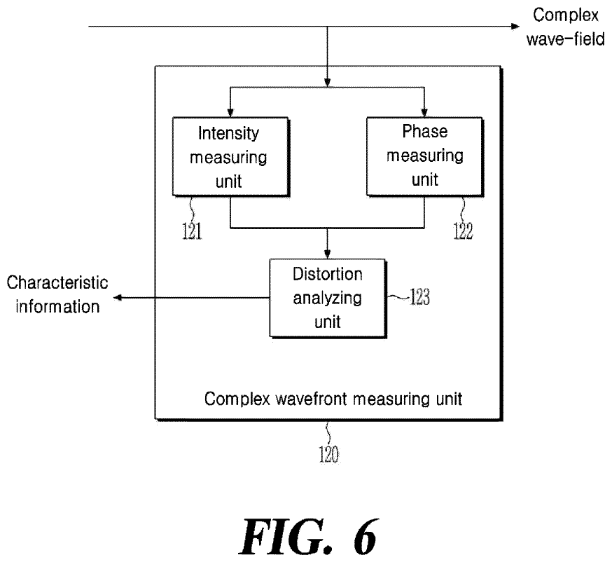

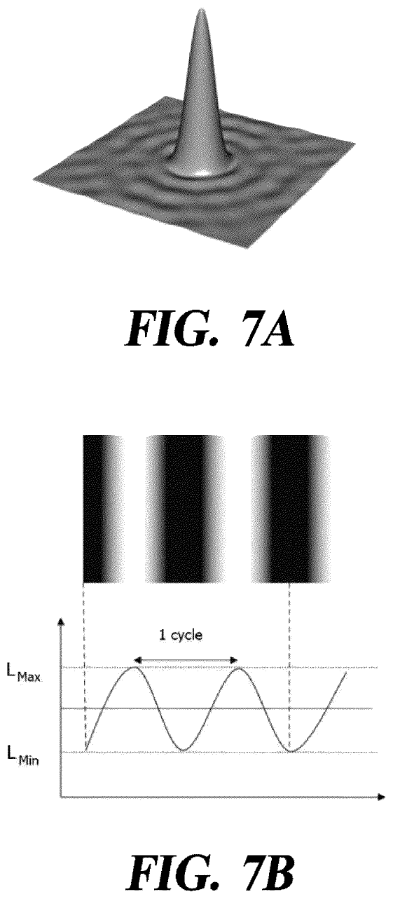

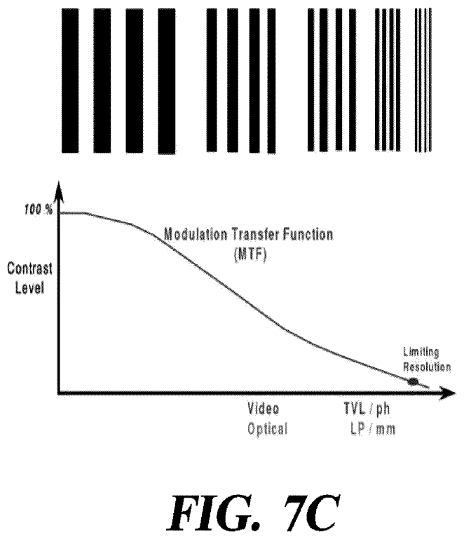

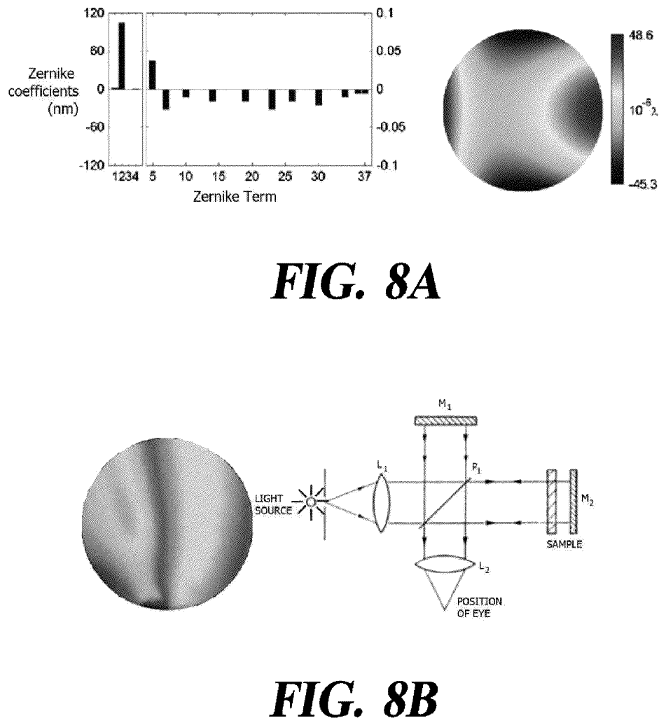

FIG. 6 is a block diagram showing a complex wavefront measuring unit according to an embodiment, FIG. 7A to FIG. 7C are diagrams showing characteristic information that can be derived from the intensity of light according to an embodiment, and FIG. 8A and FIG. 8B are diagrams showing characteristic information that can be derived from the phase of light according to an embodiment.

Referring to FIG. 6, the complex wavefront measuring unit 120 according to an embodiment may include an intensity measuring unit 121, a phase measuring unit 122, and a distortion analyzing unit 123.

The intensity measuring unit 121 may measure the intensity of a 2D restored image using an image sensor that 2-dimensionally measures the intensity of a complex light wavefront.

The phase measuring unit 122 can measure the phase of a complex light wavefront. A phase characteristic of a complex light wavefront may be derived by analyzing the phase and a distortion (wavefront aberration) of a wavefront through a sensor (e.g., Shack-Hartmann sensor) for measuring an optical wavefront. In order to precisely measure the phase of a complex light wavefront, the width, gap, etc. of interference patterns that are measured using an interferometer may be used.

The distortion analyzing unit 123 can determine characteristic information of a complex light wavefront based on the results of measuring intensity and a phase of the intensity measuring unit 121 and the phase measuring unit 122.

FIG. 7A shows a point spread function showing output for point-source input, FIG. 7B shows a contrast ratio, and FIG. 7C shows a modulation transfer function (MTF). FIG. 7A to FIG. 7C show examples of characteristic information that is obtained from intensity measured from a complex light wavefront.

FIG. 8A shows a Zernike-based phase map, which may be derived from a phase measurement result of the phase measuring unit 122. FIG. 8B shows a Twyman-Green interferometer and an interference pattern, which may be used for precise phase measurement.

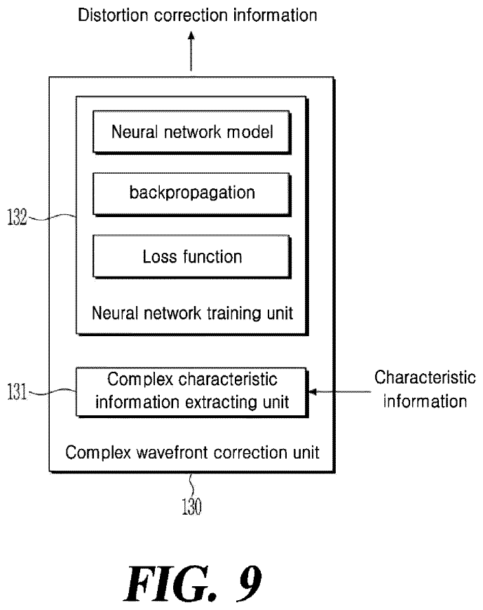

FIG. 9 is a block diagram showing a complex wavefront correction unit according to an embodiment.

The complex wavefront correction unit 130 according to an embodiment can create distortion correction information for optimizing a complex hologram by analyzing the characteristic information of a complex light wavefront based on a trained artificial neural network. Equation 5 shows a processing process of a trained artificial neural network.

$$arg {min}_{A , ϕ} \sum Loss ( c ( A , ϕ ) - {c}^{′} ( A , ϕ ) ] \qquad [ Equation 5 ]$$

In Equation 5, a loss function Loss is a function showing distortion in characteristic information c(A,ϕ) of a phase and an amplitude. In an embodiment, the complex wavefront correction unit 130 can determine distortion correction information that can minimize distortion in amplitude A and phase ϕ in a loss function using an artificial neural network. The complex wavefront correction unit 130 can use characteristic information (including intensity characteristic information and phase characteristic information) of a complex light wavefront received from the complex wavefront measuring unit 120 as training data of an artificial neural network, and can create distortion correction information for correcting distortion of a complex light wavefront using the trained artificial neural network. In this case, a dimension reduction process (e.g., Zernike polynomial) may be applied to the phase characteristic information of the complex light wavefront.

The artificial neural network that the complex wavefront correction unit 130 uses to correct and optimize distortion of the complex light wavefront may be any one of various artificial neural networks such as a convolution neural network (CNN) such as U-Net, Res-Net, etc. or a deep neural network (DNN) using supervised-learning, a Generative Adversarial Network (GAN), AutoEncoder, etc., or a combination thereof.

As described above, the apparatus for generating a hologram according to an embodiment can optimize transform of a complex hologram and consequently maximize the performance of a complex modulation SLM by creating distortion correction information through an artificial neural network based on a measurement result of a complex wave-field output from the complex modulation SLM and by feeding back the created distortion information to the complex modulation SLM.

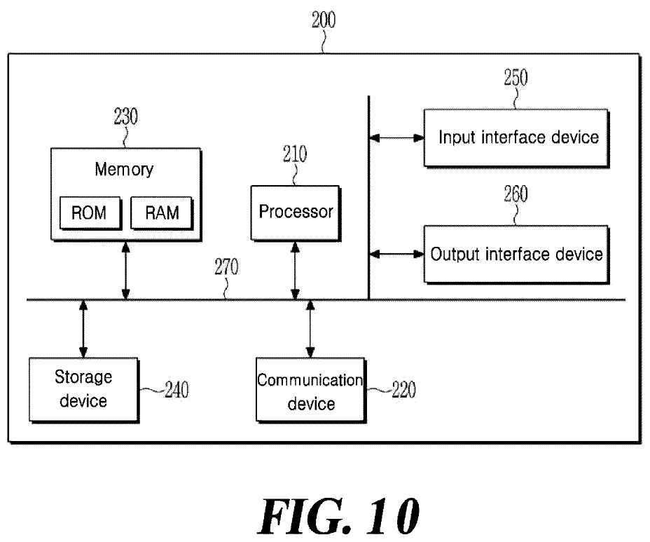

FIG. 10 is a block diagram showing an apparatus for correcting a complex hologram according to an embodiment.

An apparatus for correcting a complex hologram according to an embodiment may be implemented as a computer system, for example, a computer-readable recording medium. Referring to FIG. 10, a computer system 200 may include at least one of a processor 210, a memory 230, an input interface device 250, an output interface device 260, and a storage device 240, which communicate with each other via a bus 270. The computer device 200 may further include a communication unit 200 coupled to a network. The processor 210 may be a central processing unit (CPU) or a semiconductor device that executes instructions stored in the memory 230 or the storage device 240. The memory 230 and the storage device 240 may include various types of volatile or nonvolatile storage media. For example, the memory may include a read only memory (ROM), a random access memory (RAM), etc. In an embodiment of the present disclosure, the memory may be positioned inside or outside the processor and the memory may be connected to the processor through various known means. The memory is various types of volatile or nonvolatile storage media, and for example, the memory may include a read-only memory (ROM) or a random access memory (RAM).

Accordingly, the embodiment of the present disclosure may be implemented as a method implemented in a computer or may be implemented as a non-transitory computer-readable medium in which computer-executable instructions are stored. In one embodiment, when executed by the processor, the computer-readable instructions may perform the method according to at least one aspect of the present disclosure.

The communication device 220 can transmit or receive wired signals or wireless signals.

Meanwhile, the embodiments of the present disclosure are not implemented only through the apparatuses and/or methods described so far, but may also be implemented through a program for implementing a function corresponding to the configuration of the embodiments of the present disclosure or a recording medium having the program recorded thereon, and such an implementation can be easily implemented by those having ordinary skill in the art from the description of the embodiments described above. Specifically, the method (e.g., a network management method, a data transmission method, a transmission schedule generation method, etc.) according to the embodiments of the present disclosure may be implemented in the form of program instructions that can be executed through various computer means, and may be recorded in a computer-readable medium. The computer-readable medium may include a program instruction, a data file, a data structure, and the like, alone or in combination. The program instruction recorded in the computer-readable medium may be specially designed and configured for the embodiment of the present disclosure, or may be known to and usable by those having ordinary skill in the art of computer software. The computer-readable recording medium may include a hardware device configured to store and execute the program instruction. For example, the computer-readable recording medium may be a magnetic medium such as a hard disk, a floppy disk and a magnetic tape, an optical medium such as a CD-ROM and a DVD, a magneto-optical medium such as a floptical disk, a ROM, a RAM, a flash memory, or the like. The program instruction may include not only machine codes such as those made by a compiler, but also high-level language codes that can be executed by a computer through an interpreter.

Although the embodiments of the present disclosure have been described above in detail, the scope of the present disclosure is not limited thereto, and various modifications and improvements made by those having ordinary skill in the art using the basic concept of the present disclosure defined in the following claims also belong to the scope of the present disclosure.

What is claimed is:

1. An apparatus for generating a hologram, the apparatus comprising:
a complex wavefront measuring unit configured to measure an intensity and a phase of a complex light wavefront that is output from a complex modulation spatial light modulator (SLM), analyze the intensity and the phase of the complex light wavefront, and accordingly, determine characteristic information of the complex light wavefront; and
a complex wavefront correction unit configured to create distortion correction information for correcting distortion of the complex light wavefront from an artificial neural network by inputting the characteristic information to the artificial neural network and feeding back the distortion correction information to the complex modulation SLM.

2. The apparatus of claim 1, wherein the complex modulation SLM is configured to update the complex light wavefront using the distortion correction information.

3. The apparatus of claim 1, wherein the complex wavefront measuring unit includes:
a phase measuring unit configured to measure the phase of the complex light wavefront;
an intensity measuring unit configured to measure the intensity of the complex light wavefront; and
a distortion analyzing unit configured to determine characteristic information of the complex light wavefront by analyzing the measured phase and intensity of the complex light wavefront.

4. The apparatus of claim 3, wherein phase characteristic information derived from the measured phase of the complex light wavefront includes a Zernike-based phase map.

5. The apparatus of claim 3, wherein intensity information derived from the measured intensity of the complex light wavefront includes at least one of a point spread function, a contrast ratio, a modulation transfer function, or a combination thereof.

6. The apparatus of claim 1, wherein the complex wavefront correction unit determines distortion correction information that can minimize distortion in a loss function showing the distortion in the characteristic information using the artificial neural network.

7. The apparatus of claim 1, wherein the complex modulation SLM includes a first SLM configured to modulate a phase, a second SLM configured to modulate an amplitude, and an optical device configured to combine beams of light modulated by the first SLM and the second SLM.

8. The apparatus of claim 7, wherein the first SLM, the second SLM, and the optical device are disposed to couple beams of light modulated by the first SLM and the second SLM in a complex multiplication method or a complex addition method.

9. A method of generating a hologram, comprising:
measuring an intensity and a phase of a complex light wavefront that is output from a complex modulation spatial light modulator (SLM);
determining characteristic information of the complex light wavefront by analyzing the measured intensity and phase of the complex light wavefront;
creating distortion correction information for correcting distortion of the complex light wavefront from an artificial neural network by inputting the characteristic information to the artificial neural network; and
feeding back the distortion correction information to the complex modulation SLM.

10. The method of claim 9, further comprising:
updating the complex light wavefront using the distortion correction information.

11. The method of claim 9, wherein the measuring of an intensity and a phase of a complex light wavefront that is output from a complex modulation SLM includes:
measuring the phase of the complex light wavefront;
measuring the intensity of the complex light wavefront; and
determining characteristic information of the complex light wavefront by analyzing the measured phase and intensity of the complex light wavefront.

12. The method of claim 11, wherein phase characteristic information derived from the measured phase of the complex light wavefront includes a Zernike-based phase map.

13. The method of claim 11, wherein intensity information derived from the measured intensity of the complex light wavefront includes at least one of a point spread function, a contrast ratio, a modulation transfer function, or a combination thereof.

14. The method of claim 9, wherein the creating of distortion correction information for correcting distortion of the complex light wavefront from an artificial neural network by inputting the characteristic information to the artificial neural network includes
determining distortion correction information that can minimize distortion in a loss function showing the distortion in the characteristic information using the artificial neural network.

15. The method of claim 9, wherein before measuring an intensity and a phase of a complex light wavefront that is output from a complex modulation SLM, the method further comprises:
modulating a phase of light using a first SLM;
modulating an amplitude of the light using a second SLM; and
outputting the complex light wavefront by coupling beams of light modulated by the first SLM and the second SLM.

16. The method of claim 15, wherein the coupling of beams of light modulated by the first SLM and the second SLM includes coupling beams of light modulated by the first SLM and the second SLM in a complex multiplication method or a complex addition method.

17. An apparatus for correcting a hologram, comprising
a processor,
a memory; and
a communication interface,
wherein the processor is configured to execute programs stored in the memory, thereby performing:
receiving characteristic information of a complex light wavefront, which is determined from a result of measuring an intensity and a phase of the complex light wavefront that is output from a complex modulation spatial light modulator (SLM), from the communication interface;
creating distortion correction information for correcting distortion of the complex light wavefront from an artificial neural network by inputting the characteristic information of the complex light wavefront to the artificial neural network; and
feeding back the distortion correction information to the complex modulation SLM through the communication interface.
